(19) United States
(12) Patent Application Publication
(10) Pub. No.: US 2017/0200956 A1
(43) Pub. Date: Jul. 13, 2017

(54) ELECTRODE CATALYST FOR FUEL CELL AND METHOD OF PRODUCING ELECTRODE CATALYST FOR FUEL CELL

(71) Applicants: TOYOTA JIDOSHA KABUSHIKI KAISHA, Toyota-shi (JP); CATALER CORPORATION, Kakegawa-shi (JP)

(72) Inventors: Tetsuo NAGAMI, Nagoya-shi (JP); Hiroyuki SUGATA, Miyoshi-shi (JP); Shinya NAGASHIMA, Toyota-shi (JP); Mikihiro KATAOKA, Kakegawa-shi (JP); Akihiro HORI, Kakegawa-shi (JP)

(73) Assignees: TOYOTA JIDOSHA KABUSHIKI KAISHA, Toyota-shi (JP); CATALER CORPORATION, Kakegawa-shi (JP)

(21) Appl. No.: 15/394,129

(22) Filed: Dec. 29, 2016

(30) Foreign Application Priority Data
Jan. 8, 2016 (JP) 2016-002877

(51) Int. Cl. H01M 4/92; H01M 4/88

(52) U.S. Cl. CPC H01M 4/926; H01M 4/921; H01M 4/8882

(57) ABSTRACT

An electrode catalyst for a fuel cell includes: a carbon support having a crystallite diameter of 2.0 nm to 3.5 nm at a carbon (002) plane, and having a specific surface area of 400 m²/g to 700 m²/g; and a catalyst metal containing platinum and a platinum alloy that are supported on the carbon support, and having a crystallite diameter of 2.7 nm to 5.0 nm at a platinum (220) plane. A ratio of a peak height of a spectrum of the platinum alloy in a form of an intermetallic compound with respect to a peak height of a spectrum of platinum is 0.03 to 0.08. The spectrum of the platinum alloy and the spectrum of platinum are measured through X-ray diffraction.

### INCORPORATION BY REFERENCE

The disclosure of Japanese Patent Application No. 2016-002877 filed on Jan. 8, 2016 including the specification, drawings and abstract is incorporated herein by reference in its entirety.

### BACKGROUND

1. Technical Field

The disclosure relates to an electrode catalyst for a fuel cell, and relates also to a method of producing an electrode catalyst for a fuel cell.

2. Description of Related Art

Fuel cells generate electricity through an electrochemical reaction between hydrogen and oxygen. The by-product of electricity generation by fuel cells is theoretically only water. For this reason, fuel cells have drawn widespread attention as eco-friendly electricity-generating systems that have the least effect on the global environment.

In a fuel cell, a fuel gas containing hydrogen is supplied to an anode (fuel electrode) side and an oxidation gas containing oxygen is supplied to a cathode (air electrode) side, whereby an electromotive force is generated. In this case, an oxidation reaction represented by Chemical Equation (1) proceeds on the anode side, a reduction reaction represented by Chemical Equation (2) proceeds on the cathode side, and a reaction represented by Chemical Equation (3) proceeds as a whole. As a result, an electromotive force is supplied to an external circuit.

H₂→2H⁺+2e⁻ (1)

(½)O₂+2H⁺+2e⁻H₂O (2)

H₂+(½)O₂→H₂O (3)

Fuel cells are classified into polymer electrolyte fuel cells (PEFCs), phosphoric-acid fuel cells (PAFCs), molten-carbonate fuel cells (MCFCs), solid oxide fuel cells (SOFCs) and so forth, according to the kind of electrolyte. Among these kinds of fuel cells, PEFCs and PAFCs are usually provided with an electrode catalyst including a conductive support, such as a carbon support, and particles of a catalyst metal having a catalytic activity, such as platinum or a platinum alloy supported on the conductive support.

A carbon support included in an electrode catalyst usually has, on its surface, a graphite structure having a high specific surface area of about 800 m²/g, that is, having a low crystallinity. Particles of a catalyst metal may be highly dispersedly supported on the surface of a carbon support having a high specific surface area. For this reason, using a carbon support having a high specific surface area may enhance the mass activity (current density per unit mass) of an electrode catalyst to be obtained.

For example, WO 2007/119640 describes an electrode catalyst for a fuel cell, in which catalyst particles containing platinum and cobalt are supported on a conductive support. The electrode catalyst according to WO 2007/119640 is characterized in that the composition ratio (molar ratio) between platinum and cobalt contained in the catalyst particles is 3:1 to 5:1. According to WO 2007/119640, the conductive support is preferably furnace carbon having a specific surface area of 50 m²/g to 1000 m²/g or acetylene black having a specific surface area of 50 m²/g to 1000 m²/g. In addition, WO 2007/119640 describes the results obtained by producing the electrode catalyst for a fuel cell, using commercially available carbon black powder having a specific surface area of about 800 m²/g.

Japanese Patent Application Publication No. 2014-007050 (JP 2014-007050 A) describes a catalyst for a polymer electrolyte fuel cell, in which catalyst particles containing platinum, cobalt, and manganese are supported on carbon powder supports. The catalyst according to JP 2014-007050 A is characterized in that the composition ratio (molar ratio) among platinum, cobalt, and manganese (Pt:Co:Mn) in the catalyst particles is 1:0.06 to 0.39:0.04 to 0.33. Further, in an X-ray diffraction analysis on the catalyst particles, the ratio of a peak intensity of a Co—Mn alloy that appears in the vicinity of 2θ=27° with respect to a main peak that appears in the vicinity of 2θ=40° is 0.15 or less. JP 2014-007050 A describes the results obtained by producing the catalyst for a polymer electrolyte fuel cell, using a platinum catalyst including fine carbon powder (having a specific surface area of about 900 m²/g) as a support and having a platinum supporting ratio of 46.5 mass %.

Japanese Patent Application Publication No. 2015-035356 (JP 2015-035356 A) describes electrode catalyst particles for a fuel cell, and an electrode catalyst for a fuel cell. The electrode catalyst particles are alloy particles containing platinum atoms and non-platinum metal atoms. In the electrode catalyst particles, the ratio of an average value of bonding numbers of non-platinum metal atoms and platinum atoms with respect to an average value of bonding numbers of non-platinum metal atoms and non-platinum metal atoms is 2.0 or more. In the electrode catalyst for a fuel cell, the electrode catalyst particles for a fuel cell are supported on a conductive support. According to JP 2015-035356 A, the conductive support preferably has a specific surface area of 10 m²/g to 5000 m²/g. In addition, JP 2015-035356 A describes the results obtained by producing the electrode catalyst for a fuel cell, using a carbon support (Ketjenblack® EC-300J, average particle diameter: 40 nm, BET specific surface area: 800 m²/g, produced by Lion Corporation).

### SUMMARY

While a fuel cell is operating, a carbon support of an electrode catalyst is electrochemically oxidized due to a reaction represented by Chemical Equation (4). In accordance with the oxidation reaction, carbon dioxide transformed from carbon atoms contained in the carbon support is separated from the carbon support.

C+2H₂O→CO₂+4H⁺+4e⁻ (4)

The oxidation-reduction potential of the reaction represented by Chemical Equation (4) is about 0.2 V. Thus, while the fuel cell is operating, the reaction represented by Chemical Equation (4) may gradually proceed. As a result, when the fuel cell is operating for a long time, “thinning” of the electrode due to reduction in the number of carbon atoms in the carbon support is observed in some cases. When “thinning” of the electrode occurs, the performance of the fuel cell may be lowered. The reaction represented by Chemical Equation (4) is inhibited from proceeding in carbon having a high crystallinity graphite structure. For this reason, a carbon support having a high crystallinity graphite structure usually is highly resistant to the oxidation reaction represented by Chemical Equation (4).

In order to increase the specific surface area of a carbon support, it is necessary to modify the surface structure of the carbon support. However, when the surface structure of the carbon support is modified, the graphite structure of the surface may be disturbed. That is, increasing the specific surface area of a carbon support may result in lowering of the oxidation resistance of the carbon support. There is a certain correlation between the specific surface area of a carbon support and the number of sites at which a catalyst metal is supported on the carbon support. When the specific surface area of a carbon support decreases, the dispersibility of a catalyst metal supported on the carbon support may be lowered. This may result in lowering of the activity of an electrode catalyst to be obtained. As described above, an electrode catalyst for a fuel cell including a high crystallinity carbon support has room for performance improvement in terms of activity and durability.

In view of this, the disclosure provides an electrode catalyst for a fuel cell having both high activity and high durability, and provides a method of producing such an electrode catalyst.

As a result of various studies concerning methods for addressing the above-described problems, the inventors found that it is possible to enhance both the activity and durability of an electrode catalyst for a fuel cell in the following manner. A catalyst metal containing prescribed percentages of platinum and a platinum alloy is supported on a carbon support having a crystallite diameter at the carbon (002) plane, which is within a prescribed range, and having a specific surface area within a prescribed range. In this way, the inventors have achieved the disclosure.

A first aspect of the disclosure relates to an electrode catalyst for a fuel cell, the electrode catalyst including: a carbon support having a crystallite diameter of 2.0 nm to 3.5 nm at a carbon (002) plane, and having a specific surface area of 400 m²/g to 700 m²/g; and a catalyst metal containing platinum and a platinum alloy that are supported on the carbon support, and having a crystallite diameter of 2.7 nm to 5.0 nm at a platinum (220) plane. In the electrode catalyst, a ratio of a peak height of a spectrum of the platinum alloy in a form of an intermetallic compound with respect to a peak height of a spectrum of platinum is 0.03 to 0.08. The spectrum of the platinum alloy and the spectrum of platinum are measured through X-ray diffraction.

In the first aspect of the disclosure, the platinum alloy may be an alloy of platinum and cobalt.

In the first aspect of the disclosure, the carbon support may have a crystallite diameter of 2.4 nm to 3.5 nm at the carbon (002) plane.

In the first aspect of the disclosure, the carbon support may have a specific surface area of 400 m²/g to 500 m²/g.

In the first aspect of the disclosure, the catalyst metal may have a crystallite diameter of 2.9 nm to 4.0 nm at the platinum (220) plane.

A second aspect of the disclosure relates to a fuel cell including the above-described electrode catalyst for a fuel cell.

A third aspect of the disclosure relates to a method of producing the above-described electrode catalyst for a fuel cell. The method according to the third aspect of the disclosure includes: obtaining a carbon support having a crystallite diameter of 2.0 nm to 3.5 nm at a carbon (002) plane and having a specific surface area of 400 m²/g to 700 m²/g; causing the obtained carbon support to support a catalyst metal material containing salt of platinum and salt of a metal other than platinum constituting a platinum alloy such that a molar ratio of the salt of platinum with respect to the salt of the metal other than platinum is 2 to 3.5, by causing the carbon support to react with the catalyst metal material; and alloying platinum and the metal other than platinum by burning the carbon support on which the catalyst metal material is supported at a temperature of 600° C. to 1000° C.

In the third aspect of the disclosure, the platinum alloy may be an alloy of platinum and cobalt, and a burning temperature for alloying platinum and cobalt may be 650 to 750° C.

The third aspect of the disclosure may further include treating a catalyst metal obtained through alloying, in a nitric acid aqueous solution.

According to the disclosure, it is possible to achieve both high activity and high durability in the electrode catalyst for a fuel cell.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram showing voltage values at a relative humidity of 80% and 0.1 A/cm² in MEA evaluation of electrode catalysts of Examples 1 to 4 and Comparative Example 1;

FIG. 2 is a diagram showing voltage values at a relative humidity of 80% and 3.5 A/cm² in MEA evaluation of the electrode catalysts of Examples 1 to 4 and Comparative Example 1;

FIG. 3 is a diagram showing voltage values at a relative humidity of 30% and 0.1 A/cm² in MEA evaluation of the electrode catalysts of Examples 1 to 4 and Comparative Example 1;

FIG. 4 is a diagram showing voltage values at a relative humidity of 30% and 2.5 A/cm² in MEA evaluation of the electrode catalysts of Examples 1 to 4 and Comparative Example 1;

FIG. 5A is a diagram showing the relationship between the heat treatment temperature (alloying temperature) when alloying is performed after cobalt salt is supported on a carbon support in the course of producing the electrode catalysts of Examples 1 to 8 and Comparative Examples 1, 4 and 5, and the specific activity according to RDE evaluation performed on these electrode catalysts;

FIG. 5B is a diagram showing the relationship between the ratio of a peak height of an XRD spectrum of Pt₃Co with respect to that of Pt in the electrode catalysts of Examples 1 to 8 and Comparative Examples 1, 4 and 5, and the specific activity according to RDE evaluation performed on these electrode catalysts;

FIG. 6 is a diagram showing an XRD spectrum of the electrode catalyst of Example 4;

FIG. 7A shows images of the electrode catalyst of Comparative Example 1, which were observed by a high-resolution scanning transmission electron microscope (STEM);

FIG. 7B shows observation images of the electrode catalyst of Example 4 obtained by the high resolution scanning transmission electron microscope (STEM);

FIG. 8A is a diagram showing a gas diffusion resistance (s/m) after a durability test is performed at a relative humidity of 165% in each of Example 4 and Comparative Example 1;

FIG. 8B is a diagram showing a gas diffusion resistance (s/m) after a durability test is performed at a relative humidity of 80% in each of Example 4 and Comparative Example 1;

FIG. 8C is a diagram showing a gas diffusion resistance (s/m) after a durability test is performed at a relative humidity of 30% in each of Example 4 and Comparative Example 1;

FIG. 9 is a diagram showing a Pt—Co temperature correlation diagram (Desk Handbook, Phase Diagrams for Binary Alloys, Hiroaki Okamoto, ASMINTER NATIONAL, The Materials Information Society); and

FIG. 10 is a diagram showing the relationship among the alloying temperature, the Pt (220) crystallite diameter and the ratio of a peak height of an XRD spectrum of Pt₃Co with respect to that of Pt in electrode catalysts prepared at different alloying temperatures, where each black diamond indicates a Pt (220) crystallite diameter and each outline diamond indicates a ratio of a peak height of an XRD spectrum of Pt₃Co with respect to that of Pt.

### DETAILED DESCRIPTION OF EMBODIMENTS

Hereinafter, an example embodiment of the disclosure will be described in detail.

1. Electrode Catalyst for Fuel Cell

A first embodiment of the disclosure relates to an electrode catalyst for a fuel cell.

The electrode catalyst for a fuel cell according to the first embodiment includes a carbon support, and a catalyst metal containing platinum (Pt) and a platinum alloy that are supported on the carbon support.

In an electrode catalyst for a fuel cell in related art, a carbon support having a high specific surface area is used in order to enhance the activity of the electrode catalyst. This is because, when a carbon support having a high specific surface area is used, a catalyst metal is highly dispersedly supported on the carbon support. In general, a carbon support has a graphite crystal structure on its surface. As the crystallinity of graphite becomes higher, the thickness of a graphite crystal layer becomes greater. The thickness of a graphite crystal layer is determined based on an image obtained by a transmission electronic microscope (TEM) or a scanning transmission electron microscope (STEM), and is represented by a crystallite diameter (Lc) at the carbon (002) plane, which is determined based on an X-ray diffraction (XRD) spectrum.

In an electrode catalyst for a fuel cell, Lc of a carbon support is a physical property value that indicates a graphite structure itself formed on the surface of the carbon support. While a fuel cell is operating, oxidation of a carbon support is expected to proceed more promptly in a portion having a non-graphite structure than in a portion having a graphite structure. In addition, oxidation of a graphite structure portion of the carbon support is expected to proceed more promptly in a low crystallinity portion than in a high crystallinity portion. In an electrode catalyst for a fuel cell, when oxidation of a carbon support proceeds, movement and/or aggregation of catalyst metal particles may occur. When the catalyst metal particles of the electrode catalyst are moved and/or aggregated and become coarse, the activity of the catalyst metal may be lowered.

In view of this, it is considered that using a carbon support having a high graphite structure abundance ratio and having a high crystallinity enhances the durability (e.g. oxidation resistance) of an electrode catalyst for a fuel cell. However, a carbon support having a high crystallinity usually has a low specific surface area. For this reason, it has been difficult to obtain an electrode catalyst for a fuel cell having both high activity and high durability.

The inventors found that an electrode catalyst for a fuel cell containing a large amount of catalyst metal supported on a carbon support and having a high oxidation resistance can be obtained in the following manner. In the course of producing the electrode catalyst for a fuel cell, a catalyst metal containing prescribed percentages of platinum and a platinum alloy is supported on a carbon support having a crystallite diameter at the carbon (002) plane, which is within a prescribed range, and having a specific surface area within a prescribed range.

It is possible to evaluate the oxidation resistance of the carbon support of the electrode catalyst for a fuel cell according to the first embodiment based on, for example, the results of a high potential durability test performed on the electrode catalyst. In addition, it is possible to evaluate the activity of the electrode catalyst for a fuel cell according to the first embodiment based on, for example, the results of an MEA evaluation test performed on the electrode catalyst.

The carbon support included in the electrode catalyst for a fuel cell according to the first embodiment has a crystallite diameter (Lc) of 2.0 nm to 3.5 nm at the carbon (002) plane. The crystallite diameter (Lc) is preferably 2.4 nm to 3.5 nm, and is more preferably 2.4 nm to 3.2 nm. When the carbon support included in the electrode catalyst for a fuel cell according to the first embodiment has a crystallite diameter (Lc) of 2.0 nm to 3.5 nm, the electrode catalyst has a high oxidation resistance and/or contains a large amount of catalyst metal supported on the carbon support. Note that, an amount of catalyst metal supported on a carbon support will be referred to as “supported amount of catalyst metal”.

The crystallite diameter (Lc) can be determined by, for example, the following method. An XRD spectrum of the carbon support included in the electrode catalyst for a fuel cell is measured by an XRD device. The crystallite diameter (Lc) at the carbon (002) plane is determined according to the Scherrer equation, based on the obtained XRD spectrum.

The carbon support included in the electrode catalyst for a fuel cell according to the first embodiment has a specific surface area of 400 m²/g to 700 m²/g. The specific surface area is preferably 400 m²/g to 500 m²/g, and is more preferably 400 m²/g to 450 m²/g. When the specific surface area of the carbon support included in the electrode catalyst for a fuel cell according to the first embodiment is lower than 400 m²/g, the crystallite diameter at the platinum (220) plane in a catalyst metal containing platinum and a platinum alloy that are supported on the carbon support increases, and thus the activity of the electrode catalyst for a fuel cell to be obtained may be lowered. On the other hand, when the specific surface area of the carbon support included in the electrode catalyst for a fuel cell according to the first embodiment is higher than 700 m²/g, the crystallite diameter at the platinum (220) plane in the catalyst metal containing platinum and a platinum alloy that are supported on the carbon support decreases, and thus the durability of the catalyst metal itself may be lowered. In view of this, when the specific surface area of the carbon support included in the electrode catalyst for a fuel cell according to the first embodiment is 400 m²/g to 700 m²/g, the electrode catalyst has both high activity and high durability.

The specific surface area of the carbon support included in the electrode catalyst for a fuel cell according to the first embodiment can be determined by measuring a BET specific surface area of the carbon support included in the electrode catalyst for a fuel cell according to the first embodiment based on a gas adsorption method, using, for example, a specific surface area measurement device.

The catalyst metal included in the electrode catalyst for a fuel cell according to the first embodiment has a crystallite diameter of 2.7 nm to 5.0 nm at the platinum (220) plane. The crystallite diameter at the platinum (220) plane is preferably 2.9 nm to 4.0 nm, and is more preferably 2.9 nm to 3.5 nm. When the catalyst metal included in the electrode catalyst for a fuel cell according to the first embodiment has a crystallite diameter of less than 5.0 nm at the platinum (220) plane, the catalyst metal is highly dispersedly supported on the carbon support of the electrode catalyst. In addition, when the catalyst metal included in the electrode catalyst for a fuel cell according to the first embodiment has a crystallite diameter of greater than 2.7 nm at the platinum (220) plane, the catalyst metal itself of the electrode catalyst has high durability. In view of this, when the catalyst metal included in the electrode catalyst for a fuel cell according to the first embodiment has a crystallite diameter of 2.7 nm to 5.0 nm at the platinum (220) plane, the electrode catalyst has both high activity and high durability.

In general, in a catalyst metal included in an electrode catalyst for a fuel cell, the crystallite diameter at the platinum (220) plane may vary due to the following factors. That is, as the specific surface area of a carbon support included in an electrode catalyst for a fuel cell becomes lower, the crystallite diameter at the platinum (220) plane becomes greater. As the supported amount of platinum contained in an electrode catalyst for a fuel cell becomes greater, the crystallite diameter at the platinum (220) plane becomes greater. In addition, in the course of producing an electrode catalyst for a fuel cell, as the heat treatment temperature after platinum is supported on a carbon support is higher, the crystallite diameter at the platinum (220) plane becomes greater. Specific conditions for obtaining a catalyst metal having a crystallite diameter of 2.7 nm to 5.0 nm at the platinum (220) plane can be determined by applying a correlation between conditions, which is acquired through a preliminary experiment performed in advance in consideration of the above factors. According to such a method, it is possible to obtain a catalyst metal having a crystallite diameter of 2.7 nm to 5.0 nm at the platinum (220) plane.

The crystallite diameter at the platinum (220) plane can be determined by, for example, the following method. An XRD spectrum of a catalyst metal included in the electrode catalyst for a fuel cell is measured by an XRD device. The crystallite diameter at the platinum (220) plane is determined according to the Scherrer equation based on the obtained XRD spectrum. In addition, the crystallite diameter at the platinum (220) plane has a certain correlation with a crystallite diameter of another lattice plane of platinum, such as the platinum (111) plane. Therefore, the crystallite diameter at the platinum (220) plane may be calculated based on a crystallite diameter of another lattice plane of platinum, such as the platinum (111) plane.

The catalyst metal included in the electrode catalyst for a fuel cell according to the first embodiment contains platinum (Pt) and a platinum alloy. The platinum alloy usually contains Pt and at least one kind of metal other than Pt. In this case, examples of the metals other than Pt constituting a platinum alloy include cobalt (Co), gold (Au), palladium (Pd), nickel (Ni), manganese (Mn), iridium (Jr), iron (Fe), copper (Cu), titanium (Ti), tantalum (Ta), niobium (Nb), yttrium (Y), and lanthanoid elements, such as gadolinium (Gd), lanthanum (La), and cerium (Ce). As at least one kind of metal other than Pt constituting a platinum alloy, Co, Au, Pd, Ni, Mn, Cu, Ti, Ta or Nb is preferable, and Co is more preferable. The platinum alloy is preferably Pt₃Co. In addition, the catalyst metal included in the electrode catalyst for a fuel cell according to the first embodiment preferably has a core-shell structure including a core containing a platinum alloy as a main component and a shell containing Pt as a main component, and is more preferably has a core-shell structure including a core containing a Pt₃Co ordered alloy as a main component and a shell containing Pt as a main component. When the catalyst metal included in the electrode catalyst for a fuel cell according to the first embodiment contains a platinum alloy containing Pt and at least one kind of metal other than Pt described above, the electrode catalyst has both high activity and high durability.

In the catalyst metal included in the electrode catalyst for a fuel cell according to the first embodiment, the ratio of a peak height of an XRD spectrum of a platinum alloy in the form of an intermetallic compound with respect to that of platinum is 0.03 to 0.08. The ratio of a peak height of an XRD spectrum of a platinum alloy in the form of an intermetallic compound with respect to that of platinum is preferably 0.03 to 0.07. When at least one kind of metal other than Pt constituting a platinum alloy is Co, the platinum alloy in the form of an intermetallic compound is usually Pt₃Co. When the ratio of a peak height of an XRD spectrum of a platinum alloy in the form of an intermetallic compound with respect to that of platinum is 0.03 to 0.08, the electrode catalyst for a fuel cell according to the first embodiment include the catalyst metal having the above-described composition and structure.

The electrode catalyst for a fuel cell according to the first embodiment may include the catalyst metal having the above-described characteristics, in a supported amount of 30 mass % to 50 mass % with respect to the total mass of the electrode catalyst. The catalyst metal is more preferably included in a supported amount of 30 mass % to 40 mass % with respect to the total mass of the electrode catalyst, and is further more preferably included in a supported amount of 35 mass % to 40 mass % with respect to the total mass of the electrode catalyst. When an electrode catalyst for a fuel cell is used as a cathode of a fuel cell, the thickness of the electrode catalyst is usually about 10 μm. When a carbon support having a low bulk density is used as a carbon support included in an electrode catalyst for a fuel cell, the electrode catalyst preferably includes the catalyst metal in a large supported amount in order to achieve a desired thickness. In view of this, the electrode catalyst for a fuel cell according to the first embodiment including the catalyst metal in a supported amount of 30 mass % to 50 mass % can be appropriately used as a cathode of a fuel cell.

The composition and the supported amount of the catalyst metal can be determined in the following manner. The catalyst metal contained in the electrode catalyst is dissolved using, for example, an aqua regia, and then catalytic metal ions in the solution are determined quantitatively by an inductively-coupled plasma (ICP) atomic emission spectrometry device. The ratio of a peak height of an XRD spectrum of a platinum alloy in the form of an intermetallic compound with respect to that of platinum in a catalyst metal can be determined by, for example, measuring an XRD spectrum of the catalyst metal and then calculating a ratio of a peak height of a peak specific to the platinum alloy in the form of an intermetallic compound with respect to that of platinum. In addition, the structures of platinum and a platinum alloy in the form of an intermetallic compound in a catalyst metal can be determined based on, for example, a TEM image or a STEM image.

The electrode catalyst for a fuel cell according to the first embodiment can be applied to any one of a cathode and an anode of a fuel cell. Therefore, a second embodiment of the disclosure relates to a fuel cell including the electrode catalyst for a fuel cell according to the first embodiment. In the electrode catalyst for a fuel cell according to the first embodiment, a large amount of catalyst metal is highly dispersedly supported on the carbon support and/or has a high oxidation resistance. For this reason, the fuel cell including the electrode catalyst for a fuel cell according to the first embodiment has a high electricity generation capacity and can exhibit high durability even if it is used for a long time. When the fuel cell according to the second embodiment is employed in, for example, an automobile and is used for a long time, it is possible to stably exhibit high performance.

2. Method of Producing Electrode Catalyst for Fuel Cell

A third embodiment of the disclosure relates to a method of producing the electrode catalyst for a fuel cell described above.

2-1. Carbon Support Preparation Step

The method of producing an electrode catalyst for a fuel cell according to the third embodiment includes a carbon support preparation step. In the carbon support preparation step, a carbon support having a crystallite diameter of 2.0 nm to 3.5 nm at the carbon (002) plane and having a specific surface area of 400 m²/g to 700 m²/g is obtained.

The carbon support material used in this step may be any carbon support material usually used in this technical field. The carbon support material may be, for example, acetylene black YS (specific surface area: 105 m²/g, produced by SN2A), CA250 (specific surface area: 250 m²/g, produced by Denka Company Limited), FX35 (specific surface area: 130 m²/g, produced by Denka Company Limited), or Ketjen (specific surface area: 223 m²/g) that is graphitized under the above-described conditions of 1600° C. for 2 hours in argon. By using one of these kinds of carbon support materials, a carbon support having the above-described characteristics is obtained.

When the carbon support material used in this step has a crystallite diameter of 2.0 nm to 3.5 nm at the carbon (002) plane and a specific surface area of 400 m²/g to 700 m²/g, it is possible to use the carbon support material in the following steps without making any change. On the other hand, when the carbon support material used in this step does not have the above characteristics, the carbon support material is preferably oxidized by subjecting the carbon support material to a thermal oxidation treatment in the presence of oxygen. In this case, conditions of the thermal oxidation treatment can be set as appropriate based on a carbon support material to be used and a desired crystallite diameter (Lc) and a desired specific surface area. For example, the thermal oxidation treatment temperature is preferably 500° C. to 600° C., and is more preferably 500° C. to 540° C. The thermal oxidation treatment time at the above-described thermal oxidation treatment temperature is preferably 2 hours to 8 hours, and is more preferably 3 hours to 5 hours. The thermal oxidation treatment is preferably performed in the presence of an oxygen-containing gas, and is more preferably performed in the presence of air. By performing the thermal oxidation treatment under the above-described conditions, a carbon support having the characteristics described above is obtained.

2-2. Catalytic Metal Salt Supporting Step

The method of producing an electrode catalyst for a fuel cell according to the third embodiment includes a catalytic metal salt supporting step. In the catalytic metal salt supporting step, the carbon support obtained in the carbon support preparation step is caused to support a catalyst metal material containing salt of platinum and salt of a metal other than platinum constituting a platinum alloy, through a reaction between the carbon support and the catalyst metal material.

The salt of platinum contained in the catalyst metal material used in this step is, for example, a platinum-containing complex, such as dinitro diammineplatinum (II) nitric acid or a hexahydroxo platinum ammine complex. In addition, the salt of the metal other than platinum constituting the platinum alloy contained in the catalyst metal material used in this step may be salt of the metal other than platinum and nitric acid or acetic acid, and is preferably cobalt nitrate, nickel nitrate, manganese nitrate, cobalt acetate, nickel acetate, or manganese acetate.

The catalyst metal material used in this step contains salt of platinum and salt of a metal other than platinum constituting a platinum alloy, such that a molar ratio of salt of platinum with respect to salt of the metal other than platinum is 2 to 3.5. When the catalyst metal material contains salt of platinum and salt of a metal other than platinum constituting a platinum alloy at the above-described molar ratio, it is possible to set the composition of platinum and a platinum alloy in a catalyst metal included in the electrode catalyst for a fuel cell to be obtained according to the present embodiment, to a composition within a desired range.

This step can be performed using a reaction that is usually used in this technical field, for example, by a colloidal method or a deposition precipitation method.

In this step, the order of causing a reaction between the carbon support and the catalyst metal material containing salt of platinum and salt of a metal other than platinum constituting a platinum alloy is not limited to any particular order. Preferably, the carbon support is caused to react with salt of platinum and is then caused to react with salt of the metal other than platinum constituting the platinum alloy. In the third embodiment, after the carbon support is caused to react with salt of platinum, the reactant may undergo a heat treatment in the presence of an inert gas. In this case, the heat treatment temperature is preferably 600° C. to 1000° C., and is more preferably 650° C. to 750° C. The heat treatment time at the above-described heat treatment temperature is preferably 1 hour to 6 hours, and is more preferably 1 hour to 2 hours. The inert gas is preferably argon, nitrogen, or helium, and is more preferably argon. In this step, by causing the carbon support to react with the salt of platinum and then subjecting the reactant to the heat treatment under the above-described conditions, platinum in a metallic form is obtained from the salt of platinum.

2-3. Alloying Step

The method of producing an electrode catalyst for a fuel cell according to the third embodiment includes an alloying step. In the alloying step, platinum and the metal other than platinum are alloyed by burning the carbon support on which the catalyst metal material is supported. The carbon support on which the catalyst metal material is supported is obtained in the catalytic metal salt supporting step.

In this step, the temperature at which the carbon support, on which the catalyst metal material is supported, is burned is 600° C. to 1000° C. The burning temperature is preferably 650° C. to 750° C. When the metal other than platinum is cobalt, by setting the burning temperature in this step to 650° C. to 750° C., an alloy of platinum and cobalt is appropriately formed. The burning time is preferably 1 hour to 6 hours, and is more preferably 1 hour to 3 hours. The burning is preferably performed in the presence of an inert gas. The inert gas is preferably argon, nitrogen, or helium, and is more preferably argon. In this step, when the carbon support on which the catalyst metal material is supported is burned under the above-described conditions, platinum and the metal other than platinum are alloyed from the salt of the metal other than platinum, whereby platinum in a metallic form and a platinum alloy are formed. In the catalytic metal salt supporting step, the carbon support may be caused to react with the salt of platinum, and then the reactant may be subjected to a heat treatment under the above-described conditions and then caused to react with the salt of the metal other than platinum constituting the platinum alloy. In this case, when the alloying step is performed under the above-described conditions subsequent to the catalytic metal salt supporting step, it is possible to form a catalyst metal having a core-shell structure including a core containing the platinum alloy as a main component and a shell containing Pt as a main component.

2-4. Nitric Acid Treatment Step

The method of producing an electrode catalyst for a fuel cell according to the third embodiment may further include a nitric acid treatment step. In the nitric acid treatment step, the catalyst metal obtained in the alloying step is treated with a nitric acid aqueous solution. When the catalyst metal obtained in the alloying step is treated with the nitric acid aqueous solution, it is possible to remove at least a part of an oxide of the metal other than platinum, which remains in the catalyst metal, and/or at least a part of the metal other than platinum constituting the platinum alloy present on a surface of the catalyst metal. Thus, it is possible to substantially prevent formation of ions of the metal other than platinum, which may inhibit proton conduction. In addition, it is possible to form a catalyst metal having the core-shell structure described above.

The concentration of the nitric acid aqueous solution used in this step is preferably 0.1 N to 2 N. The temperature of the nitric acid treatment is preferably 40° C. to 80° C. In addition, the nitric acid treatment time is preferably 0.5 hours to 24 hours. When this step is performed under the above-described conditions, it is possible to substantially prevent formation of ions of the metal other than platinum, which may inhibit proton conduction. In addition, it is possible to form a catalyst metal having the core-shell structure described above.

With the method of producing an electrode catalyst for a fuel cell according to the third embodiment, it is possible to obtain an electrode catalyst for a fuel cell having the above-described characteristics and having high activity and high durability.

Hereinafter, the embodiments will be described in further detail with reference to examples. However, the technical scope of the embodiments is not limited to the following examples.

I. Preparation of Electrode Catalyst

I-1-1. Example 1

First, 10 g of acetylene black YS (specific surface area: 105 m²/g, produced by SN2A) was prepared through weighting performed using a porcelain dish, and was then placed in an electric furnace. The temperature in the electric furnace was increased to 500° C. over 1.5 hours. The acetylene black YS was heated at 500° C. for 5 hours, whereby a carbon support was obtained. Then, 1500 g of a nitric acid aqueous solution (0.1 N) was added to 12 g of the obtained carbon support, and the carbon support was dispersed in the nitric acid aqueous solution. A dinitro diammineplatinum (II) nitric acid solution containing Pt in a Pt charged amount (8 g), which was set such that a Pt supported amount was to be 40 mass % with respect to the total mass of a final product, was added to the dispersion solution, and then 99.5% ethanol (100 g) was added to the dispersion solution. The mixture was sufficiently stirred until the mixture was substantially homogenized, and was then heated under the conditions of 60° C. to 95° C. for 3 hours. After the heating was completed, the obtained dispersion solution was repeatedly subjected to filtration and purified until the conductivity of a filtration drainage became 5 μS/cm or less. The obtained solid content was dried by blowing air at 80° C. for 15 hours. The powder obtained through drying was subjected to a heat treatment (conditions: the temperature was increased at 5° C./min and kept at 700° C. for 2 hours) at 700° C. in argon gas (catalytic metal salt supporting step). The obtained Pt (40 mass %) supported carbon support was dispersed in pure water of which the mass was 80 times as large as the total mass of the carbon support. A cobalt nitrate aqueous solution was delivered by drops into the dispersion solution until the molar ratio of Pt with respect to Co became 2. The cobalt nitrate aqueous solution was prepared by dissolving a commercially available cobalt nitrate hexahydrate in pure water. After the cobalt nitrate aqueous solution was delivered by drops into the dispersion solution, sodium borohydride diluted with pure water was delivered by drops into the obtained mixture until the molar ratio of Pt with respect to Co became 1 to 6. After the sodium borohydride was delivered by drops into the mixture, the obtained mixture was stirred for 1 hour to 20 hours. After the stirring, the obtained dispersion solution was repeatedly subjected to filtration and purified until the conductivity of a filtration drainage became 5 μS/cm or less. The obtained solid content was dried by blowing air at 80° C. for 15 hours. The powder obtained through drying was subjected to a heat treatment (conditions: the temperature was increased at 5° C./min and kept at 700° C. for 2 hours) at 700° C. in argon gas, whereby an alloy was obtained (alloying step). Subsequently, the obtained powder was treated under the conditions of 40° C. to 80° C. for 0.5 hours to 24 hours in a nitric acid aqueous solution (0.1 N to 2 N), whereby electrode catalyst powder was obtained (nitric acid treatment step).

I-1-2. Example 2

In Example 2, electrode catalyst powder was obtained in the same manner as that in Example 1, except that the heat treatment temperature for treating acetylene black YS was changed to 510° C., and the addition amount of the dinitro diammineplatinum (II) nitric acid solution was changed to an amount at which the dinitro diammineplatinum (II) nitric acid solution contains Pt in a Pt charged amount (5.14 g), which was set such that a Pt supported amount was to be 30 mass % with respect to the total mass of a final product.

I-1-3. Example 3

In Example 3, electrode catalyst powder was obtained in the same manner as that in Example 1, except that the heat treatment temperature for treating acetylene black YS was changed to 510° C.

I-1-4. Example 4

In Example 4, electrode catalyst powder was obtained in the same manner as that in Example 1, except that the heat treatment temperature for treating acetylene black YS was changed to 540° C.

I-1-5. Example 5

In Example 5, electrode catalyst powder was obtained in the same manner as that in Example 1, except that the heat treatment temperature for treating acetylene black YS was changed to 540° C., the addition amount of the cobalt nitrate aqueous solution was changed to an amount at which the molar ratio of Pt with respect to Co was 3.1, and the heat treatment temperature in the alloying step performed after cobalt salt was supported on the carbon support was changed to 650° C.

I-1-6. Example 6

In Example 6, electrode catalyst powder was obtained in the same manner as that in Example 1, except that the heat treatment temperature for treating acetylene black YS was changed to 540° C., the addition amount of the cobalt nitrate aqueous solution was changed to an amount at which the molar ratio of Pt with respect to Co was 3.4, and the heat treatment temperature in the alloying step performed after cobalt salt was supported on the carbon support was changed to 750° C.

I-1-7. Example 7

In Example 7, electrode catalyst powder was obtained in the same manner as that in Example 1, except that acetylene black was changed to CA250 (produced by Denka Company Limited), the heat treatment temperature was changed to 510° C., the addition amount of the cobalt nitrate aqueous solution was changed to an amount at which the molar ratio of Pt with respect to Co was 3.5, and the heat treatment temperature in the alloying step performed after cobalt salt was supported on the carbon support was changed to 670° C.

I-1-8. Example 8

In Example 8, electrode catalyst powder was obtained in the same manner as that in Example 1, except that acetylene black was changed to CA250 (produced by Denka Company Limited), the heat treatment temperature was changed to 510° C., and the heat treatment temperature in the alloying step performed after cobalt salt was supported on the carbon support was changed to 670° C.

I-1-9. Example 9

In Example 9, electrode catalyst powder was obtained in the same manner as that in Example 4, except that the addition amount of the cobalt nitrate aqueous solution was changed to an amount at which the molar ratio of Pt with respect to Co was 2.2.

I-1-10. Example 10

In Example 10, electrode catalyst powder was obtained in the same manner as that in Example 1, except that acetylene black was changed to FX35 (produced by Denka Company Limited), the heat treatment temperature was changed to 510° C., the addition amount of the cobalt nitrate aqueous solution was changed to an amount at which the molar ratio of Pt with respect to Co was 3.5, and the heat treatment temperature in the alloying step after cobalt salt was supported on the carbon support was changed to 670° C.

I-1-11. Example 11

In Example 11, electrode catalyst powder was obtained in the same manner as that in Example 1, except that acetylene black was changed to graphitized Ketjen, the heat treatment temperature was changed to 400° C., and the addition amount of the cobalt nitrate aqueous solution was changed to an amount at which the molar ratio of Pt with respect to Co was 3.5.

I-1-12. Example 12

In Example 12, electrode catalyst powder was obtained in the same manner as that in Example 1, except that acetylene black was changed to graphitized Ketjen, the heat treatment temperature was changed to 430° C., and the addition amount of the cobalt nitrate aqueous solution was changed to an amount at which the molar ratio of Pt with respect to Co was 3.5.

I-2-1. Comparative Example 1

In Comparative Example 1, 1500 g of a nitric acid aqueous solution (0.1 N) was added to 12 g of a carbon OSAB (specific surface area: 800 m²/g, produced by Denka Company Limited), and the carbon OSAB was dispersed in the nitric acid aqueous solution. A dinitro diammineplatinum (II) nitric acid solution containing Pt in a Pt charged amount (12 g), which was set such that a Pt supported amount was to be 50 mass % with respect to the total mass of a final product, was added to the dispersion solution, and then 99.5% ethanol (100 g) was added to the dispersion solution. The mixture was sufficiently stirred until the mixture was substantially homogenized, and was then heated under the conditions of 60° C. to 95° C. for 3 hours. After the heating was completed, the obtained dispersion solution was repeatedly subjected to filtration and purified until the conductivity of a filtration drainage became 5 μS/cm or less. The obtained solid content was dried by blowing air at 80° C. for 15 hours. The powder obtained through drying was subjected to a heat treatment (conditions: the temperature was increased at 5° C./min and kept at 800° C. for 2 hours) at 800° C. in argon gas. The obtained Pt (50 mass %) supported carbon support was dispersed in pure water of which the mass was 80 times as large as the total mass of the carbon support. A cobalt nitrate aqueous solution was delivered by drops into the dispersion solution until the molar ratio of Pt with respect to Co became 4.5. The cobalt nitrate aqueous solution was prepared by dissolving a commercially available cobalt nitrate hexahydrate in pure water. After the cobalt nitrate aqueous solution was delivered by drops into the dispersion solution, sodium borohydride diluted with pure water was delivered by drops into the obtained mixture until the molar ratio of Pt with respect to Co became 1 to 6. After the sodium borohydride was delivered by drops into the mixture, the obtained mixture was stirred for 1 hour to 20 hours. After the stirring, the obtained dispersion solution was repeatedly subjected to filtration and purified until the conductivity of a filtration drainage became 5 μS/cm or less. The obtained solid content was dried by blowing air at 80° C. for 15 hours. The powder obtained through drying was subjected to a heat treatment (conditions: the temperature was increased at 5° C./min and kept at 800° C. for 2 hours) at 800° C. in argon gas, whereby an alloy was obtained. Subsequently, the obtained powder was treated under the conditions of 40° C. to 80° C. for 0.5 hours to 24 hours in a nitric acid aqueous solution (0.1 N to 2 N), whereby electrode catalyst powder was obtained.

I-2-2. Comparative Example 2

In Comparative Example 2, 20 g of acetylene black YS (specific surface area: 105 m²/g, produced by SN2A) was dispersed in a nitric acid aqueous solution (1N), and was treated at 80° C. for 21 hours. The obtained dispersion solution was filtered and the residues were dried, whereby a carbon support was obtained. Then, 1500 g of a nitric acid aqueous solution (0.1 N) was added to 12 g of the obtained carbon support, and the carbon support was dispersed in the nitric acid aqueous solution. A dinitro diammineplatinum (II) nitric acid solution containing Pt in a Pt charged amount (8 g), which was set such that a Pt supported amount was to be 40 mass % with respect to the total mass of a final product, was added to the dispersion solution, and then 99.5% ethanol (100 g) was added to the dispersion solution. The mixture was sufficiently stirred until the mixture was substantially homogenized, and was then heated under the conditions of 60° C. to 95° C. for 3 hours. After the heating was completed, the obtained dispersion solution was repeatedly subjected to filtration and purified until the conductivity of a filtration drainage became 5 μS/cm or less. The obtained solid content was dried by blowing air at 80° C. for 15 hours. The powder obtained through drying was subjected to a heat treatment (conditions: the temperature was increased at 5° C./min and kept at 700° C. for 2 hours) at 700° C. in argon gas. The obtained Pt (40 mass %) supported carbon support was dispersed in pure water of which the mass was 80 times as large as the total mass of the carbon support. A cobalt nitrate aqueous solution was delivered by drops into the dispersion solution until the molar ratio of Pt with respect to Co became 2. The cobalt nitrate aqueous solution was prepared by dissolving a commercially available cobalt nitrate hexahydrate in pure water. After the cobalt nitrate aqueous solution was delivered by drops into the dispersion solution, sodium borohydride diluted with pure water was delivered by drops into the obtained mixture until the molar ratio of Pt with respect to Co became 1 to 6. After the sodium borohydride was delivered by drops into the mixture, the obtained mixture was stirred for 1 hour to 20 hours. After the stirring, the obtained dispersion solution was repeatedly subjected to filtration and purified until the conductivity of a filtration drainage became 5 μS/cm or less. The obtained solid content was dried by blowing air at 80° C. for 15 hours. The powder obtained through drying was subjected to a heat treatment (conditions: the temperature was increased at 5° C./min and kept at 700° C. for 2 hours) at 700° C. in argon gas, whereby an alloy was obtained. Subsequently, the obtained powder was treated under the conditions of 40° C. to 80° C. for 0.5 hours to 24 hours in a nitric acid aqueous solution (0.1 N to 2 N), whereby electrode catalyst powder was obtained.

I-2-3. Comparative Example 3

In Comparative Example 3, electrode catalyst powder was obtained in the same manner as that in Comparative Example 2, except that the method of preparing a carbon support was changed to a method in which 10 g of acetylene black YS (specific surface area: 105 m²/g, produced by SN2A) was obtained through weighting performed using a porcelain dish and then placed in an electric furnace, the temperature in the electric furnace was increased to 540° C. over 1.5 hours, and heating was then performed at 540° C. for 5 hours, whereby a carbon support was obtained, and the addition amount of the cobalt nitrate aqueous solution was changed to an amount at which the molar ratio of Pt with respect to Co was 4.

I-2-4. Comparative Example 4

In Comparative Example 4, electrode catalyst powder was obtained in the same manner as that in Comparative Example 2, except that the method of preparing a carbon support was changed to a method in which 10 g of acetylene black YS (specific surface area: 105 m²/g, produced by SN2A) was obtained through weighting performed using a porcelain dish and then placed in an electric furnace, the temperature in the electric furnace was increased to 540° C. over 1.5 hours, and heating was then performed at 540° C. for 5 hours, whereby a carbon support was obtained, and the heat treatment temperature in a step performed after cobalt salt was supported on the carbon support was changed to 600° C.

I-2-5. Comparative Example 5

In Comparative Example 5, electrode catalyst powder was obtained in the same manner as that in Comparative Example 2, except that the method of preparing a carbon support was changed to a method in which 10 g of acetylene black YS (specific surface area: 105 m²/g, produced by SN2A) was obtained through weighting performed using a porcelain dish and then placed in an electric furnace, the temperature in the electric furnace was increased to 540° C. over 1.5 hours, and heating was then performed at 540° C. for 5 hours, whereby a carbon support was obtained, and the heat treatment temperature in a step performed after cobalt salt was supported on the carbon support was changed to 800° C.

I-2-6. Comparative Example 6

In Comparative Example 6, electrode catalyst powder was obtained in the same manner as that in Comparative Example 1, except that the addition amount of the dinitro diammineplatinum (II) nitric acid solution was changed to an amount at which the dinitro diammineplatinum (II) nitric acid solution contains Pt in a Pt charged amount (5.14 g), which was set such that a Pt supported amount was to be 30 mass % with respect to the total mass of a final product, and the heat treatment temperature in a step performed after cobalt salt was supported on the carbon support was changed to 800° C.

II. Evaluation Method for Electrode Catalyst

II-1. Crystallite Diameter (Lc) of Carbon Support at Carbon (002) Plane

An XRD device (Rint2500, produced by Rigaku Corporation) was used to measure an XRD spectrum of a carbon support before a catalyst metal used for preparing an electrode catalyst in each of Examples and Comparative Examples was supported on a carbon support. Measurement conditions were as follows: Cu tube, 50 kV, 300 mA. The crystallite diameter at the carbon (002) plane was determined according to the Scherrer equation based on the obtained XRD spectrum.

II-2. Specific Surface Area of Carbon Support

A specific surface area measurement device (BELSORP-mini; produced by BEL JAPAN, INC.) was used to measure a BET specific surface area (m²/g) of a carbon support before a catalyst metal used for preparing an electrode catalyst in each of Examples and Comparative Examples was supported on a carbon support, based on a gas adsorption method. Measurement conditions were as follows: pretreatment: 150° C., 2 hours vacuum deaeration, measurement: measurement of an adsorption isotherm by using nitrogen based on a constant-volume method.

II-3. Measurement of Supported Amount of Catalyst Metal

The catalyst metal contained in a prescribed amount of electrode catalyst in each of Examples and Comparative Examples is dissolved using an aqua regia. An inductively-coupled plasma (ICP) emission spectroscopy device (ICPV-8100, produced by Shimadzu Corporation) was used to quantitatively determine catalytic metal ions in the obtained solution. The supported amount (mass % with respect to the total mass of the electrode catalyst) of the catalyst metal (Pt and Co) supported on the electrode catalyst was determined from the quantitative value.

II-4. Crystallite Diameter at Platinum (220) Plane

The XRD device (Rint2500, produced by Rigaku Corporation) was used to measure an XRD spectrum of an electrode catalysts in each of Examples and Comparative Examples. Measurement conditions were as follows: Cu tube, 50 kV, 300 mA. The crystallite diameter at the carbon (002) plane was determined according to the Scherrer equation based on the obtained XRD spectrum.

II-5. Ratio of Peak Height of XRD Spectrum of Platinum Alloy in Form of Intermetallic Compound with Respect to THAT of Platinum

According to the same manner and measurement conditions as those in II-1, an XRD spectrum of an electrode catalyst in each of Examples and Comparative Examples was measured. The ratio of a peak height of an XRD spectrum of a platinum alloy in the form of an intermetallic compound with respect to that of platinum was determined from a peak height corresponding to platinum (Pt) and a peak height corresponding to a platinum alloy (Pt3Co) in the form of an intermetallic compound, based on the obtained XRD spectrum.

II-6. Electronic Microscope Observation of Electrode Catalyst

A scanning transmission electron microscope (STEM) (JEM-2100F, produced by JEOL Ltd.) was used to observe the surface of a carbon support of an electrode catalyst in each of Examples and Comparative Examples. According to a wet dispersion method, samples of the electrode catalysts were prepared and structures of electrode catalyst particles were observed at an acceleration voltage of 200 kV and a magnification of 10,000,000.

II-7. MEA Evaluation of Electrode Catalyst

First, 1 g of electrode catalyst was suspended in water. Nafion® DE2020 solution (produced by DuPont) serving as an ionomer and ethanol were added to the suspension. The obtained suspension was stirred overnight and was then subjected to a dispersion treatment using an ultrasonic homogenizer to prepare an ink solution. Components of the ink solution were added together such that the mass ratio of the ionomer to the carbon support (ionomer/carbon support) was 0.65, the mass ratio of water to ethanol and water (water/(ethanol+water)) was 8, and the mass ratio of the ink solution to the carbon support (ink solution/carbon support) was 28. The ink solution was applied to the surface of a Nafion® electrolyte membrane such that a prescribed Pt weight per unit area is achieved, by a spray method, whereby a cathode was made. An anode was connected to the cathode by a hot press method, whereby an MEA was made. In the anode, Ketjenblack® on which 30% Pt was supported is used as an electrode catalyst and Nafion® DE2020 was used as an ionomer. The Pt weight per unit area of the anode was 0.05 mg/cm², and the mass ratio of the ionomer to the carbon support (ionomer/carbon support) was 1.0. Hydrogen (0.5 L/min) was distributed to the anode and air (2 L/min) was distributed to the cathode, with the bipolar relative humidity of the obtained MEA adjusted to 100%. The running-in operation was performed four times, from a current density of 0.1 A/cm² to a high current density range in which a voltage value was 0.2 V or higher. After the bipolar relative humidity of the MEA was adjusted to 30%, the IV performance was measured. Subsequently, the bipolar relative humidity of the MEA was adjusted to 80%, and then the IV performance was measured.

II-8. RDE Evaluation of Electrode Catalyst

First, 4 to 5 mg of electrode catalyst was suspended in 1 ml of water. A prescribed amount of Nafion® DE2020 solution (produced by DuPont) serving as an ionomer and 8.5 ml of ethanol were added to the suspension. The obtained suspension was subjected to a dispersion treatment using an ultrasonic homogenizer to prepare an ink solution. The ink solution was sucked into a microsyringe. The ink solution was discharged from the microsyringe onto a rotated working electrode. Then, the ink solution was dried, whereby a working electrode to which a cathode was applied was made. The obtained working electrode was placed on an RDE evaluation device. A 0.1 N HClO₄ solution was used as an electrolytic solution, and a hydrogen electrode was used as a reference electrode. While nitrogen was bubbled, a potential cycle of 50 mV and 1200 mV was repeated 600 cycles for cleaning. Then, the bubbling was switched to bubbling of oxygen, a working electrode was rotated under the conditions of 2500, 1600, 900 and 400 rpm, and an oxygen reduction current was measured. The specific activity was calculated from the obtained measurement value, the mass activity, and the electrochemical surface area (ECSA).

II-9. Evaluation of High Potential Durability of Electrode Catalyst

An MEA was made in the same manner as that in 11-7. The obtained MEA was used to perform a running-in operation in the same manner as that in 11-7. Then, hydrogen (0.5 L/min) was distributed to the anode and nitrogen (2 L/min) was distributed to the cathode, with the bipolar relative humidity of the MEA adjusted to 100%. The state in which 1.3 V was applied to the cathode with respect to the anode using a potentiostat was maintained for 2 hours (high potential durability). Then, the bipolar relative humidity of the MEA was adjusted to 165%, the cathode gas was then switched to a cathode gas having a ratio O₂/N₂ of 1% (2 L/min), and IV sweep between 0.95 V and 0.1 V was performed 7 cycles. The gas diffusion resistance was calculated from the value of the maximum current density at the seventh cycle. Subsequently, the bipolar relative humidity of the MEA was adjusted to 80%, and the gas diffusion resistance was then calculated in the same manner. Further, the bipolar relative humidity of the MEA was adjusted to 30%, and the gas diffusion resistance was then calculated in the same manner.

III. Results of Evaluation of Electrode Catalyst

III-1. Preparation Condition and Physical Property Value of Electrode Catalyst

The overview of preparation conditions for the electrode catalysts in Examples and Comparative Examples and physical property values of the electrode catalysts are shown in Table 1.

TABLE 1

| | | | Catalyst metal | | | | Performance evaluation | | | | | |
|---|---|---|---|---|---|---|---|---|---|---|---|---|
| | | | Pt | | | | | MEA | MEA | MEA | MEA | |
| | | | (220) | | | | MEA | evaluation | evaluation | evaluation | evaluation | |
| | Carbon support | | crys- | | Producing method | | evaluation | voltage | voltage | voltage | voltage | RDE |
| | | Specific | tallite | Pt₃Co/Pt | | Alloying | Pt weight | (V) | (V) | (V) | (V) | evaluation |
| | | surface | diam- | peak | Pt/Co | temper- | per | (@0.1 | (@3.5 | (@0.1 | (@2.5 | specific |
| | Lc | area | eter | height | molar | ature | unit area | A/cm² | A/cm² | A/cm² | A/cm² | activity |
| | (nm) | (m²/g) | (nm) | ratio | ratio | (° C.) | (mg/cm²) | 80% RH) | 80% RH) | 30% RH) | 30% RH) | (A/cm²) |
| Example 1 | 3.0 | 431 | 3.3 | 0.036 | 2 | 700 | 0.204 | 0.850 | 0.340 | 0.840 | 0.450 | 640 |
| Example 2 | 2.7 | 444 | 2.9 | 0.034 | 2 | 700 | 0.199 | 0.857 | 0.352 | 0.837 | 0.437 | 625 |
| Example 3 | 2.7 | 444 | 3.1 | 0.031 | 2 | 700 | 0.192 | 0.849 | 0.347 | 0.840 | 0.461 | 730 |
| Example 4 | 3.2 | 451 | 3.1 | 0.037 | 2 | 700 | 0.203 | 0.851 | 0.369 | 0.840 | 0.441 | 720 |
| Example 5 | 3.2 | 451 | 3.2 | 0.035 | 3.1 | 650 | | | | | | 441 |
| Example 6 | 3.2 | 451 | 3.1 | 0.034 | 3.4 | 750 | | | | | | 478 |
| Example 7 | 2.6 | 632 | 3.1 | 0.048 | 3.5 | 670 | | | | | | 519 |
| Example 8 | 2.6 | 632 | 3.1 | 0.070 | 2 | 670 | | | | | | 675 |
| Example 9 | 3.2 | 451 | 3.1 | 0.056 | 2.2 | 700 | | | | | | 537 |
| Example 10 | 2.6 | 456 | 3.8 | 0.031 | 3.5 | 670 | | | | | | 660 |
| Example 11 | 2.4 | 421 | 4.1 | 0.040 | 3.5 | 700 | | | | | | 719 |
| Example 12 | 2.4 | 507 | 4 | 0.038 | 3.5 | 700 | | | | | | 671 |
| Comparative | 1.8 | 800 | 3.8 | 0.024 | 4.5 | 800 | 0.380 | 0.846 | 0.330 | 0.842 | 0.379 | 357 |
| Example 1 | | | | | | | | | | | | |
| Comparative | 3.2 | 141 | 5.2 | 0.036 | 2 | 700 | | | | | | 700 |
| Example 2 | | | | | | | | | | | | |
| Comparative | 3.2 | 451 | 3.2 | 0.026 | 4 | 700 | | | | | | 362 |
| Example 3 | | | | | | | | | | | | |
| Comparative | 3.2 | 451 | 3.1 | 0.029 | 2 | 600 | | | | | | 370 |
| Example 4 | | | | | | | | | | | | |
| Comparative | 3.2 | 451 | 3.1 | 0.024 | 2 | 800 | | | | | | 384 |
| Example 5 | | | | | | | | | | | | |
| Comparative | 1.8 | 800 | 2.6 | 0.030 | 4.5 | 800 | | | | | | 355 |
| Example 6 | | | | | | | | | | | | |

In the electrode catalyst of Comparative Example 1, carbon having a crystallite diameter (Lc) of 2 nm or less, that is, carbon having a typical high specific surface area used in the related art, was used as a carbon support. The carbon support used in the electrode catalyst of Comparative Example 1 had a small crystallite diameter (Lc) of 1.8 nm. Therefore, in the electrode catalyst of Comparative Example 1, the carbon support was assumed to have low crystallinity and the oxidation resistance of the carbon support was assumed to be insufficient.

In the electrode catalyst of Comparative Example 2, carbon having a specific surface area of 400 m²/g or lower was used as a carbon support. The carbon support used in the electrode catalyst of Comparative Example 2 had a specific surface area increased to 141 m²/g by performing a nitric acid treatment on acetylene black YS serving as a carbon material used in the electrode catalysts of the Examples. The carbon support used in the electrode catalyst of Comparative Example 2 had a higher Lc value than that of the carbon support used in the electrode catalyst of Comparative Example 1, and thus has a high crystallinity. On the other hand, because the carbon support used in the electrode catalyst of Comparative Example 2 had a low specific surface area, the Pt (220) crystallite diameter of a catalyst metal supported on the carbon support had a value greater than 5 nm. Therefore, the electrode catalyst of Comparative Example 2 had insufficient catalytic activity.

The electrode catalyst of Comparative Example 3 was produced by a method in which platinum salt and cobalt salt were used under conditions that the molar ratio of Pt with respect to Co was higher than 3.5. In the electrode catalyst of Comparative Example 3, formation of Pt₃Co, which is a platinum alloy, was insufficient.

The electrode catalyst of Comparative Example 4 was produced by a method in which the heat treatment temperature when alloying was performed after cobalt salt was supported on the carbon support was set to a temperature of lower than 650° C. The electrode catalyst of Comparative Example 5 was produced by a method in which the heat treatment temperature when alloying was performed after cobalt salt was supported on the carbon support was set to a temperature of higher than 750° C. In both the electrode catalysts of Comparative Examples 4 and 5, formation of Pt₃Co, which is a platinum alloy, was insufficient.

In the electrode catalyst of Comparative Example 6, carbon having a specific surface area of higher than 500 m²/g was used as a carbon support. The Pt (220) crystallite diameter of a catalyst metal supported on the carbon support was a value of less than 2.7 nm. Therefore, in the electrode catalyst of Comparative Example 6, the durability was insufficient.

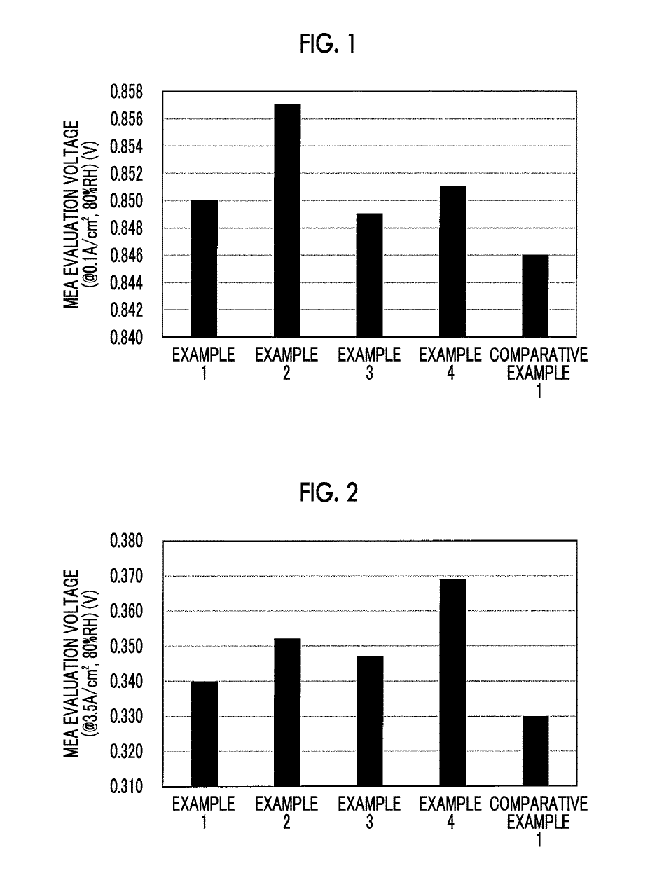

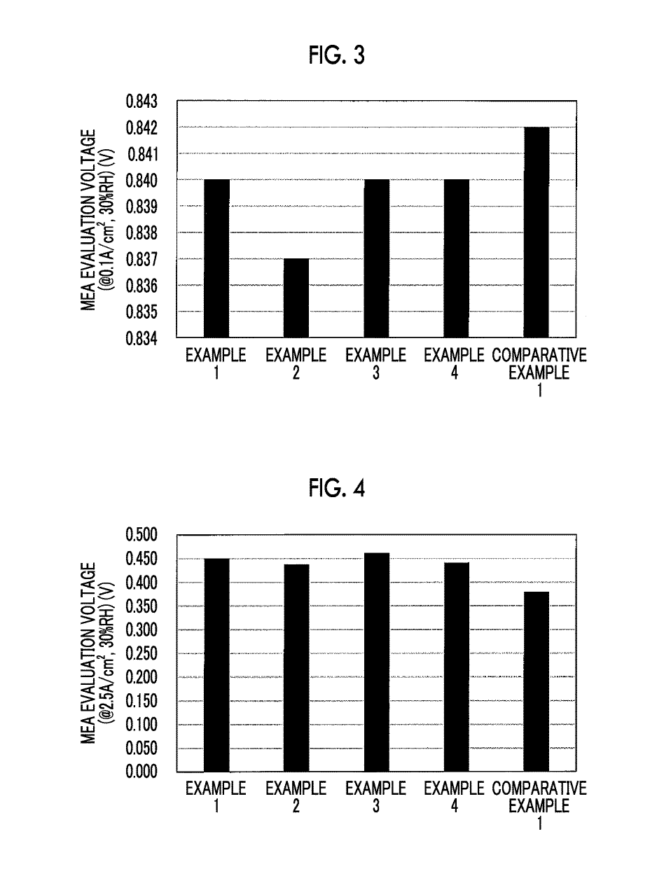

The results of MEA evaluations of the electrode catalysts of Examples 1 to 4 and Comparative Example 1 are shown in FIGS. 1 to 4. FIG. 1 and FIG. 2 respectively show voltage values at 0.1 A/cm² and 3.5 A/cm² and at a relative humidity of 80%. FIG. 3 and FIG. 4 respectively show voltage values at 0.1 A/cm² and 2.5 A/cm² at a relative humidity of 30%. In the electrode catalysts of Examples 1 to 4, the Pt weight per unit area was about 0.2 mg/cm². In the electrode catalyst of Comparative Example 1, the Pt weight per unit area was 0.38 mg/cm². While the electrode catalysts of Examples 1 to 4 had a lower Pt weight per unit area than that of the electrode catalyst of Comparative Example 1, the voltage value of each of the electrode catalysts of Examples 1 to 4 was substantially the same as the voltage value of the electrode catalyst of Comparative Example 1 at a low current density (see FIG. 1 and FIG. 3), and the voltage value of each of the electrode catalysts of Examples 1 to 4 was higher than the voltage value of the electrode catalyst of Comparative Example 1 at a high current density (see FIG. 2 and FIG. 4).

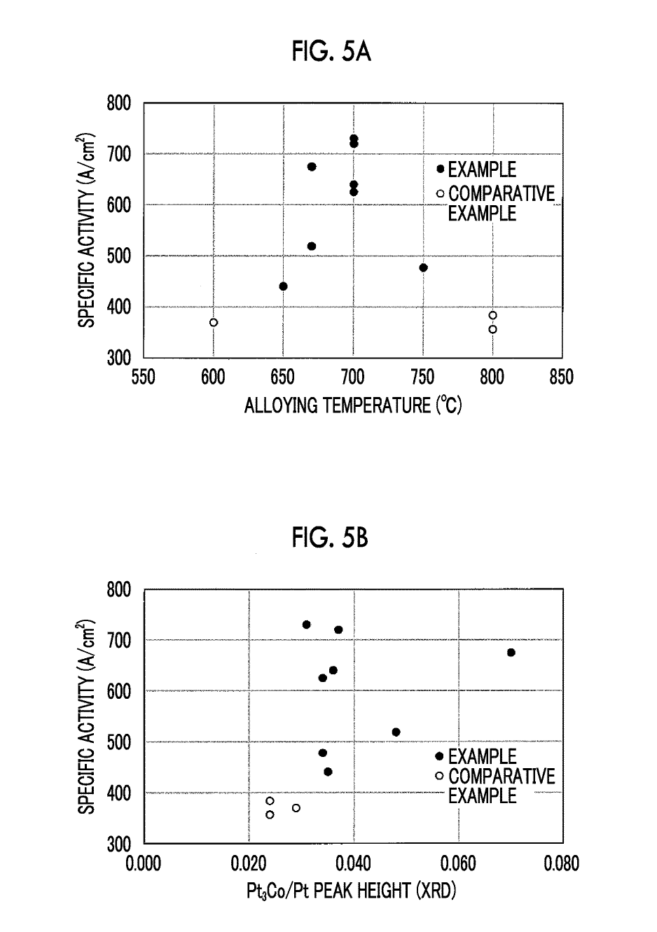

FIG. 5A shows the relationship between the heat treatment temperature (alloying temperature) when alloying is performed after cobalt salt is supported on the carbon support in the course of producing the electrode catalysts of Examples 1 to 8 and Comparative Examples 1, 4 and 5, and the specific activity according to RDE evaluation performed on these electrode catalysts. FIG. 5B shows the relationship between the ratio of a peak height of an XRD spectrum of Pt₃Co with respect to that of Pt in the electrode catalysts of Examples 1 to 8 and Comparative Examples 1, 4 and 5, and the specific activity according to RDE evaluation performed on these electrode catalysts. The specific activity according to the RDE evaluation refers to a reaction current value per Pt unit surface area. In addition, while catalyst metals were supported on the same carbon supports at the same Pt supported amount (40 mass %) in all of the electrode catalysts of Examples 4 to 6 and Comparative Examples 4 and 5, alloying temperatures in the course of producing these electrode catalysts were different from each other. As shown in FIG. 5A and FIG. 5B, the value of specific activity of Example 4, which exhibited the highest specific activity, was about twice (720 A/cm²) as high as the specific activity (357 A/cm²) of the electrode catalyst in the related art (Comparative Example 1). As described above, the electrode catalysts of Examples had a high specific activity. Therefore, although the Pt weight per unit area of each of the electrode catalysts of Examples was lower than that of the electrode catalyst of Comparative Example 1, the electrode catalysts of Examples were assumed to exhibit performance equal to or higher than that of the electrode catalyst of Comparative Example 1, in the MEA evaluation (see FIGS. 1 to 4).

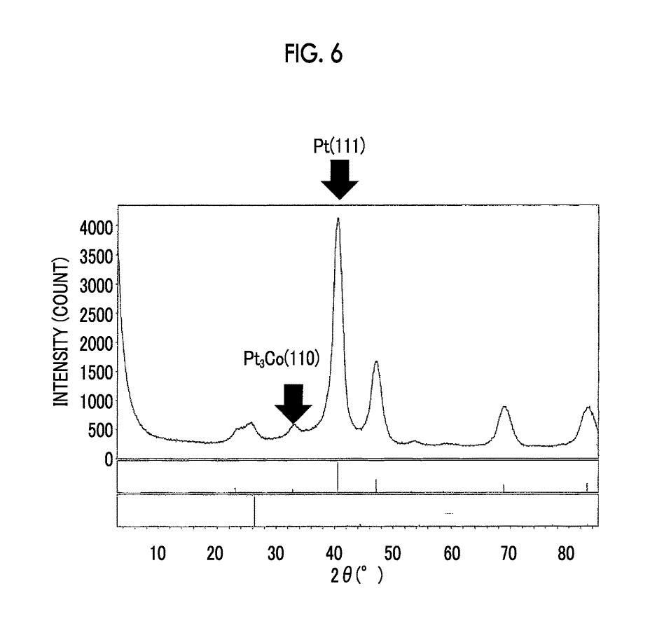

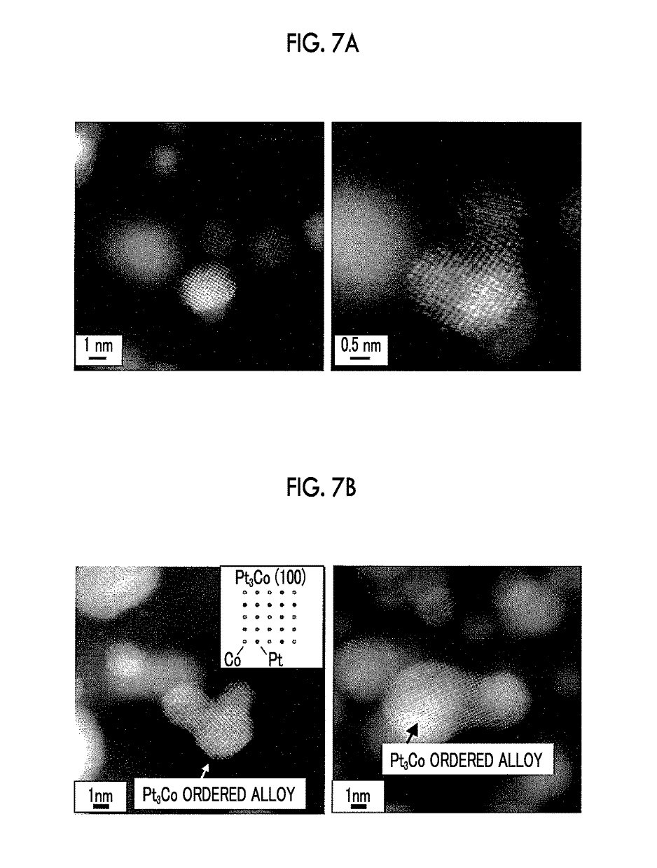

FIG. 6 shows an XRD spectrum of the electrode catalyst of Example 4. As shown in FIG. 6, in the XRD spectrum of the electrode catalyst of Example 4, a peak specific to Pt₃Co was detected. FIG. 7A shows images of the electrode catalyst of Comparative Example 1, which were observed by a high-resolution scanning transmission electron microscope (STEM). FIG. 7B shows images of the electrode catalyst of Example 4, which were observed by the high-resolution scanning transmission electron microscope (STEM). As shown in FIG. 7A, a crystal structure of Pt was observed in the STEM image of the electrode catalyst of Comparative Example 1. Based on the result, in the electrode catalyst of Comparative Example 1, a catalyst metal in the form of an alloy in which Co was contained, in a solid solution state, in a crystal structure of Pt, was assumed to be formed. On the other hand, as shown in FIG. 7B, a structure in which the core was a Pt₃Co ordered alloy was observed in the STEM image of the electrode catalyst of Example 4. Based on the results in FIG. 6, FIG. 7A, and FIG. 7B, a high activity exhibited by each of the electrode catalysts of Examples was assumed to be caused due to the formation of the catalyst metal having a structure in which the core was a Pt₃Co ordered alloy.

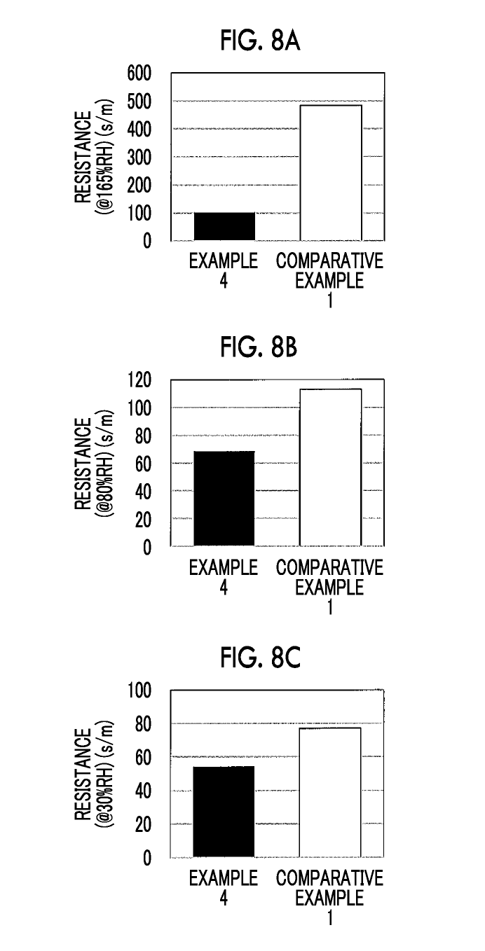

FIGS. 8A to 8C show the results of high potential durability evaluation of the electrode catalysts of Example 4 and Comparative Example 1. FIG. 8A shows a gas diffusion resistance (s/m) after a durability test was performed at a relative humidity of 165%. FIG. 8B shows a gas diffusion resistance (s/m) after a durability test was performed at a relative humidity of 80%. FIG. 8C shows a gas diffusion resistance (s/m) after a durability test was performed at a relative humidity of 30%. As shown in FIGS. 8A to 8C, in all the cases, the resistance value of the electrode catalyst of Example 4 was lower than the resistance value of the electrode catalyst of Comparative Example 1. These results were assumed to be caused due to high crystallinity of the carbon support.

According to the results described above, in order to form a catalyst metal having a structure in which the core is a Pt₃Co ordered alloy and to optimize the Pt (220) crystallite diameter in the catalyst metal, a carbon support having a specific surface area within a prescribed range is used as a carbon support on which the catalyst metal is supported.

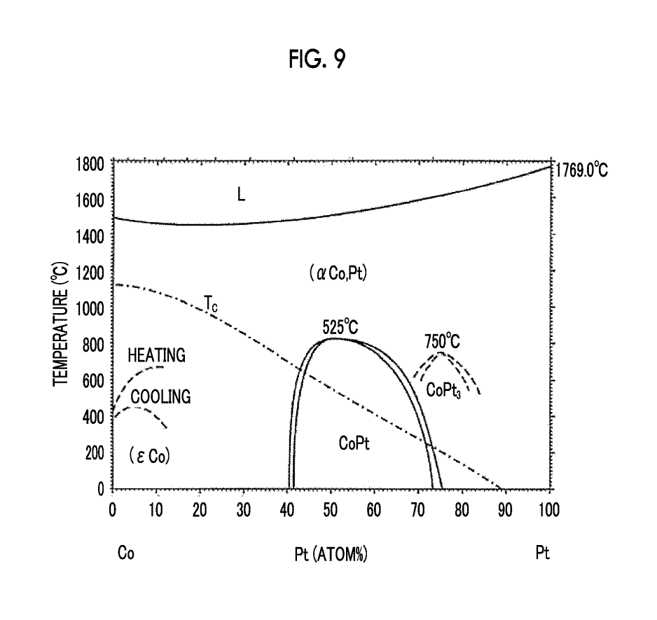

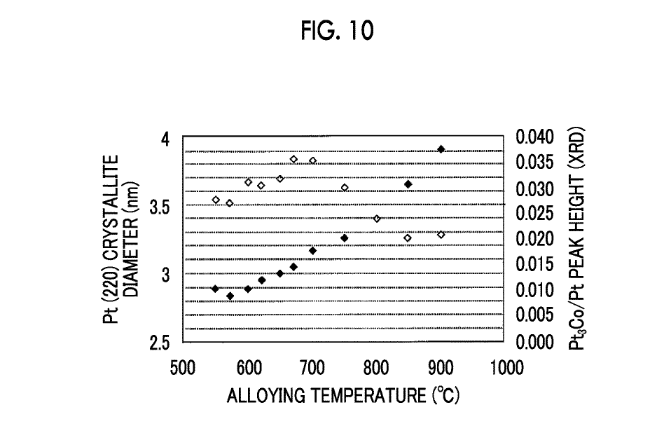

FIG. 9 shows a Pt—Co temperature correlation diagram (Desk Handbook, Phase Diagrams for Binary Alloys, Hiroaki Okamoto, ASMINTER NATIONAL, The Materials Information Society). As shown in FIG. 9, the temperature at which Pt₃Co was formed was 600° C. to 750° C. Several kinds of electrode catalyst powder were obtained in the same manner as that in Example 1, except that the heat treatment temperature for treating acetylene black YS was changed to 540° C., an addition amount of a cobalt nitrate aqueous solution was changed to an amount at which the molar ratio of Pt with respect to Co was 2, and the condition of the heat treatment in the alloying step after cobalt salt was supported on a carbon support was changed to a condition in which a heat treatment temperature was 550° C., 575° C., 600° C., 625° C., 650° C., 675° C., 700° C., 750° C., 800° C., 850° C., or 900° C. and powder was remained for 5 hours. FIG. 10 shows the relationship among the alloying temperature, the Pt (220) crystallite diameter and the ratio of a peak height of an XRD spectrum of Pt₃Co with respect to that of Pt in the obtained electrode catalysts. In FIG. 10, each black diamond indicates a Pt (220) crystallite diameter and each outline diamond indicates the ratio of a peak height of an XRD spectrum of Pt₃Co with respect to that of Pt. As shown in FIG. 10, the ratio of a peak height of an XRD spectrum of Pt₃Co with respect to that of Pt was high when the alloying temperature was 650° C. to 750° C. As a result, as can be seen from the correlation diagram of FIG. 9, a large amount of Pt₃Co was formed when the alloying temperature was 650° C. to 750° C. In addition, these results closely match the results in FIG. 5A showing that the electrode catalysts produced at an alloying temperature of 650° C. to 750° C. showed a high specific activity.

What is claimed is:

1. An electrode catalyst for a fuel cell, the electrode catalyst comprising:
a carbon support having a crystallite diameter of 2.0 nm to 3.5 nm at a carbon (002) plane, and having a specific surface area of 400 m²/g to 700 m²/g; and
a catalyst metal containing platinum and a platinum alloy that are supported on the carbon support, and having a crystallite diameter of 2.7 nm to 5.0 nm at a platinum (220) plane,
wherein a ratio of a peak height of a spectrum of the platinum alloy in a form of an intermetallic compound with respect to a peak height of a spectrum of platinum is 0.03 to 0.08, the spectrum of the platinum alloy and the spectrum of platinum being measured through X-ray diffraction.

2. The electrode catalyst for the fuel cell according to claim 1, wherein the platinum alloy is an alloy of platinum and cobalt.

3. The electrode catalyst for the fuel cell according to claim 1, wherein the carbon support has a crystallite diameter of 2.4 nm to 3.5 nm at the carbon (002) plane.

4. The electrode catalyst for the fuel cell according to claim 1, wherein the carbon support has a specific surface area of 400 m²/g to 500 m²/g.

5. The electrode catalyst for the fuel cell according to claim 1, wherein the catalyst metal has a crystallite diameter of 2.9 nm to 4.0 nm at the platinum (220) plane.

6. A fuel cell comprising the electrode catalyst for the fuel cell according to claim 1.

7. A method of producing the electrode catalyst for the fuel cell according to claim 1, the method comprising:
obtaining a carbon support having a crystallite diameter of 2.0 nm to 3.5 nm at a carbon (002) plane and having a specific surface area of 400 m²/g to 700 m²/g;
causing the obtained carbon support to support a catalyst metal material containing salt of platinum and salt of a metal other than platinum constituting a platinum alloy such that a molar ratio of the salt of platinum with respect to the salt of the metal other than platinum is 2 to 3.5, by causing the carbon support to react with the catalyst metal material; and
alloying platinum and the metal other than platinum by burning the carbon support on which the catalyst metal material is supported at a temperature of 600° C. to 1000° C.

8. The method of producing the electrode catalyst for the fuel cell according to claim 7, wherein:
the platinum alloy is an alloy of platinum and cobalt; and
a burning temperature for alloying platinum and cobalt is 650° C. to 750° C.

9. The method of producing the electrode catalyst for the fuel cell according to claim 7, further comprising treating a catalyst metal obtained through alloying, in a nitric acid aqueous solution.
